(19) United States
(12) Patent Application Publication
(10) Pub. No.: US 2013/0207737 A1
(43) Pub. Date: Aug. 15, 2013

(54) WIDEBAND NEGATIVE-PERMITTIVITY AND NEGATIVE-PERMEABILITY METAMATERIALS UTILIZING NON-FOSTER ELEMENTS

(71) Applicants: Thomas P. Weldon, Charlotte, NC (US); Ryan S. Adams, Charlotte, NC (US); Konrad Miehle, Mesa, AZ (US)

(72) Inventors: Thomas P. Weldon, Charlotte, NC (US); Ryan S. Adams, Charlotte, NC (US); Konrad Miehle, Mesa, AZ (US)

(73) Assignee: University of North Carolina at Charlotte, Charlotte, NC (US)

(21) Appl. No.: 13/766,249

(22) Filed: Feb. 13, 2013

Related U.S. Application Data
(60) Provisional application No. 61/597,875, filed on Feb. 13, 2012.

(51) Int. Cl. H01B 11/00

(52) U.S. Cl. CPC H01B 11/00
USPC 333/23

(57) ABSTRACT

A metamaterial simultaneously exhibiting a relative effective permeability and a relative effective permittivity below unity over a wide bandwidth, including: one of a two-dimensional and a three-dimensional arrangement of unit cells, wherein each of the unit cells has a magnetic dipole moment and an electric dipole moment that are dependent upon one or more of an incident magnetic field and an incident electric field; and a coupling mechanism operable for coupling one or more of the incident magnetic field and the incident electric field to one or more devices. Optionally, the coupling mechanism includes one or more of a split ring and a pair of parallel plates coupled by one of a rod and a wire. The one or more devices are non-Foster elements.

### CROSS-REFERENCE TO RELATED APPLICATION(S)

The present patent application/patent claims the benefit of priority of co-pending U.S. Provisional Patent Application No. 61/597,875, filed on Feb. 13, 2012, and entitled “WIDEBAND NEGATIVE-PERMITTIVITY METAMATERIALS AND NEGATIVE-PERMEABILITY METAMATERIALS,” the contents of which are incorporated in full by reference herein.

### STATEMENT REGARDING FEDERALLY SPONSORED RESEARCH OR DEVELOPMENT

The U.S. Government may have certain rights in the present invention pursuant to National Science Foundation Grant No. ECCS-1101939.

### FIELD OF THE INVENTION

The present invention relates generally to the fields of electrical engineering and materials science. More specifically, the present invention relates to wideband negative-permittivity and negative-permeability metamaterials utilizing non-Foster elements.

### BACKGROUND OF THE INVENTION

Metamaterials are defined as artificial materials that are engineered to have properties that are not found in nature, and that are not necessarily possessed by their constituent parts alone. In this sense, metamaterials are assemblies of multiple individual elements or unit cells, and they may be on any scale, from nano to bulk.

Metamaterials offer tremendous potential in a wide range of applications, including, but not limited to, negative refraction, wideband antennas near metal, flat lenses, and cloaking Although there has been considerable progress in passive metamaterials, the bandwidth of these devices remains limited by the resonant behavior of the fundamental particles or unit cells comprising the metamaterials. In contrast, non-Foster circuit elements offer the possibility of achieving performance capabilities well beyond the reach of passive components. As is well known to those of ordinary skill in the art, non-Foster circuit elements are those that do not obey Foster's theorem. A complete wideband double-negative metamaterial design has remained elusive, but is provided by the present invention through the use of non-Foster circuit elements. As is also well known to those of ordinary skill in the art, non-Foster circuit elements can be constructed from arrangements of capacitors, inductors, and active devices, such as Linvill circuits, current conveyors, cross-coupled transistors, tunnel diodes, etc.

The closest known art (although not necessarily pre-dating the present invention) is that of Colburn et al. (U.S. Patent Application Publication No. 2012/0256811). Colburn et al. provide:
A tunable impedance surface, the tunable surface including a plurality of elements disposed in a two dimensional array; and an arrangement of variable negative reactance circuits for controllably varying negative reactance between at least selected ones of adjacent elements in the aforementioned two dimensional array.

The tunable impedance surface of Colburn et al., however, suffers from several significant shortcomings, including, but not limited to: the fact that it is inherently limited to a two-dimensional (2-D) surface, rather than a three-dimensional (3-D) volume; its requirement for a ground plane; and the fact that it only addresses 2-D negative inductance methods, rather than 3-D negative permittivity methods, negative permeability methods, and double-negative metamaterials that exhibit simultaneous negative permittivity and negative permeability. Further, the tunable impedance surface of Colburn et al. considers the stability of non-Foster circuits, but does not consider a metamaterial design wherein a negative capacitive element or negative inductive element is combined with a positive capacitive element or positive inductive element, resulting in a stable element with a net positive inductance or net positive capacitance.

### BRIEF SUMMARY OF THE INVENTION

In various exemplary embodiments, the present invention provides a novel wideband double-negative metamaterial having simultaneous negative relative permittivity and negative relative permeability (with both relative permittivity Eᵣ and relative permeability μᵣ below 0), from 1.0 to 4.5 GHz, for example. Further, in various exemplary embodiments, the present invention provides a novel wideband metamaterial having simultaneous permittivity and permeability below 1 (with both relative permittivity εᵣ and relative permeability μᵣ below 1), from 1.0 to 4.5 GHz, for example. Non-Foster loads, such as negative capacitors, negative inductors, and negative resistors, which operate at many frequencies, are coupled to electric and/or magnetic fields using single split-ring resonators (SSRRs), electric disk resonators (EDRs) consisting of two metal disks connected by a metal rod or wire, and other suitable coupling devices. The designs of the loads for the SSRR and EDR that comprise the unit cell are based on an analysis of the coupled fields. The required negative inductance load of the SSRR is derived using Faraday's law of induction, the geometry of the coupling device, and the incident magnetic field. The required negative capacitance load of the EDR is derived using Ampere's circuital law, the geometry of the coupling device, and the incident electric field. The results from Faraday's law and Ampere's law are then used to compute the magnetic and electric dipole moments of the unit cell, and to derive the effective permittivity and effective permeability. This straightforward analysis leads to a relatively simple expression for the resulting negative effective permittivity and negative effective permeability of the unit cell as a function of frequency, with the elimination of typical resonant behavior. As is well known to those of ordinary skill in the art, mixing effects, such as the Maxwell Garnett equation, Bruggeman's Effective Medium Theory, and the Landau-Lifshits-Looyenga mixing rule, are included in a more detailed analysis.

In one exemplary embodiment, the present invention provides a metamaterial exhibiting an effective relative permeability below unity over a wide bandwidth, including: one of a two-dimensional and a three-dimensional arrangement of unit cells, wherein each of the unit cells has a magnetic dipole moment that is dependent upon one or more of an incident magnetic field and an incident electric field; and a coupling mechanism operable for coupling one or more of the incident magnetic field and the incident electric field to a device. Optionally, the coupling mechanism is a split ring. Other exemplary coupling mechanisms that can be used include SSRRs, EDRs, double split-ring resonators (DSRRs), electric-LC resonators, omega particles, capacitively-loaded strips, cut-wire pairs, complementary split-ring resonators (CSRRs), dipoles, asymmetric triangular electromagnetic resonators, S-shaped resonators, etc. The device is a non-Foster element. Optionally, the non-Foster element includes an arrangement of one or more negative capacitors. Alternatively, the non-Foster element includes an arrangement of one or more negative inductors. Alternatively, the non-Foster element includes an arrangement of one or more negative resistors. Alternatively, the non-Foster element includes an arrangement of a negative capacitor in parallel with a negative inductor. Other possibilities, of course, include various combinations and arrangements of negative capacitors, negative inductors, positive capacitors, positive inductors, resistors, negative resistors, transistors, and/or diodes to achieve the desired frequency dependent non-Foster impedances.

In another exemplary embodiment, the present invention provides a metamaterial exhibiting an effective relative permittivity below unity over a wide bandwidth, including: one of a two-dimensional and a three-dimensional arrangement of unit cells, wherein each of the unit cells has an electric dipole moment that is dependent upon one or more of an incident magnetic field and an incident electric field; and a coupling mechanism operable for coupling one or more of the incident magnetic field and the incident electric field to a device. Optionally, the coupling mechanism is a pair of parallel plates coupled by one of a rod and a wire. Other exemplary coupling mechanisms that can be used include EDRs, SSRRs, DSRRs, electric-LC resonators, omega particles, capacitively-loaded strips, cut-wire pairs, CSRRs, dipoles, asymmetric triangular electromagnetic resonators, S-shaped resonators, etc. The device is a non-Foster element. Optionally, the non-Foster element includes an arrangement of one or more negative capacitors. Alternatively, the non-Foster element includes an arrangement of one or more negative inductors. Alternatively, the non-Foster element includes an arrangement of one or more negative resistors. Other possibilities, of course, include various combinations and arrangements of negative capacitors, negative inductors, positive capacitors, positive inductors, resistors, negative resistors, transistors, and/or diodes to achieve the desired frequency dependent non-Foster impedances.

In a further exemplary embodiment, the present invention provides a metamaterial simultaneously exhibiting an effective relative permeability and an effective relative permittivity below unity over a wide bandwidth, including: one of a two-dimensional and a three-dimensional arrangement of unit cells, wherein each of the unit cells has a magnetic dipole moment and an electric dipole moment that are dependent upon one or more of an incident magnetic field and an incident electric field; and a coupling mechanism operable for coupling one or more of the incident magnetic field and the incident electric field to a device. Optionally, the coupling mechanism includes one or more of a split ring and a pair of parallel plates coupled by one of a rod and a wire. Other exemplary coupling mechanisms that can be used include SSRRs, EDRs, DSRRs, electric-LC resonators, omega particles, capacitively-loaded strips, cut-wire pairs, CSRRs, dipoles, asymmetric triangular electromagnetic resonators, S-shaped resonators, etc. The device is a non-Foster element. Optionally, the non-Foster element includes an arrangement of one or more negative capacitors. Alternatively, the non-Foster element includes an arrangement of one or more negative inductors. Alternatively, the non-Foster element includes an arrangement of one or more negative resistors. Alternatively, the non-Foster element includes an arrangement of a negative capacitor in parallel with a negative inductor. Other possibilities, of course, include various combinations and arrangements of negative capacitors, negative inductors, positive capacitors, positive inductors, resistors, negative resistors, transistors, and/or diodes to achieve the desired frequency dependent non-Foster impedances.

### BRIEF DESCRIPTION OF THE DRAWINGS

The present invention is illustrated and described herein with reference to the various drawings, in which like reference numbers are used to denote like structural components/method steps, as appropriate, and in which:

FIG. 1 is a schematic diagram illustrating one exemplary embodiment of a magnetic unit cell of the metamaterial of the present invention, the magnetic unit cell incorporating a single split-ring resonator (SSRR) coupling device and a non-Foster element;

FIGS. 2a-2c are schematic diagrams illustrating exemplary embodiments of an electric unit cell of the metamaterial of the present invention, the electric unit cell incorporating an electric disk resonator (EDR) coupling device and a non-Foster element;

FIG. 3 is a schematic diagram illustrating one exemplary embodiment of the double-negative metamaterial structure of the present invention, the structure incorporating three SSRR and three EDR coupling devices and six non-Foster elements;

FIG. 4 is a plot illustrating exemplary simulation results for the structure of FIG. 3;

FIG. 5 is a plot illustrating exemplary extracted values of the real parts of the effective relative permeability μᵣ and effective relative permittivity εᵣ for the structure of FIG. 3;

FIG. 6 is a plot illustrating further exemplary simulation results for the structure of FIG. 3 when all three EDR coupling devices are removed; and

FIG. 7 is a plot illustrating exemplary extracted values of the real and imaginary parts of the permeability μᵣ for the structure of FIG. 3 when all three EDR coupling devices are removed.

### DETAILED DESCRIPTION OF THE INVENTION

Again, in various exemplary embodiments, the present invention provides a novel wideband double-negative metamaterial having simultaneous negative effective relative permittivity and negative effective relative permeability (with both relative permittivity εᵣ and relative permeability μᵣ below 0), from 1.0 to 4.5 GHz, for example. Further, in various exemplary embodiments, the present invention provides a novel wideband metamaterial having simultaneous effective relative permittivity and effective relative permeability below 1 (with both relative permittivity εᵣ and relative permeability μᵣ below 1), from 1.0 to 4.5 GHz, for example. Non-Foster loads, such as negative capacitors, negative inductors, and negative resistors, which operate at many frequencies, are coupled to electric and/or magnetic fields using SSRRs, EDRs consisting of two metal disks connected by a metal rod or wire, and other suitable coupling devices. The designs of the loads for the SSRR and EDR that comprise the unit cell are based on an analysis of the coupled fields. The required negative inductance load of the SSRR is derived using Faraday's law of induction, the geometry of the coupling device, and the incident magnetic field. The required negative capacitance load of the EDR is derived using Ampere's circuital law, the geometry of the coupling device, and the incident electric field. The results from Faraday's law and Ampere's law are then used to compute the magnetic and electric dipole moments of the unit cell, and to derive the effective permittivity and permeability. This straightforward analysis leads to a relatively simple expression for the resulting negative effective permittivity and negative effective permeability of the unit cell as a function of frequency, with the elimination of typical resonant behavior. As is well known to those of ordinary skill in the art, mixing effects, such as the Maxwell Garnett equation, Bruggeman's Effective Medium Theory, and the Landau-Lifshits-Looyenga mixing rule, are included in a more detailed analysis.

The analyses and results of the present invention address the problem of narrow bandwidth in double-negative metamaterials, negative permittivity metamaterials, negative permeability metamaterials, metamaterials incorporating electromagnetic coupling devices, and metamaterials with effective relative permittivity and/or effective relative permeability below unity. In this, properly chosen non-Foster loads are shown to provide wideband negative effective permittivity, wideband negative effective permeability, wideband double-negative metamaterials, wideband electromagnetic coupling, and wideband metamaterials with relative permittivity and/or relative permeability below unity. In particular, the permeability of an SSRR becomes independent of frequency with a negative inductance load, and the permittivity of an EDR becomes independent of frequency with a negative capacitor load. Similar results for loop and dipole antennas have been noted. As is well known to those of ordinary skill in the art, various combinations and arrangements of negative capacitors, negative inductors, positive capacitors, positive inductors, resistors, negative resistors, transistors, and/or diodes to achieve the desired frequency dependent non-Foster impedances.

The design of a non-Foster-loaded SSRR with wideband negative effective permeability is first considered. The design of a non-Foster-loaded EDR with wideband negative effective permittivity is then considered. Finally, simulation results of wideband double-negative metamaterials are given, with effective permittivity and permeability extracted from the S-parameters of the metamaterial.

The well-known theory of an elementary lossless SSRR is first considered, since it is useful in describing the overall analysis approach for the proposed negative-permittivity metamaterials. Although other magnetic field coupling devices may have advantages and may be used, they would unnecessarily complicate the basic development outlined here.

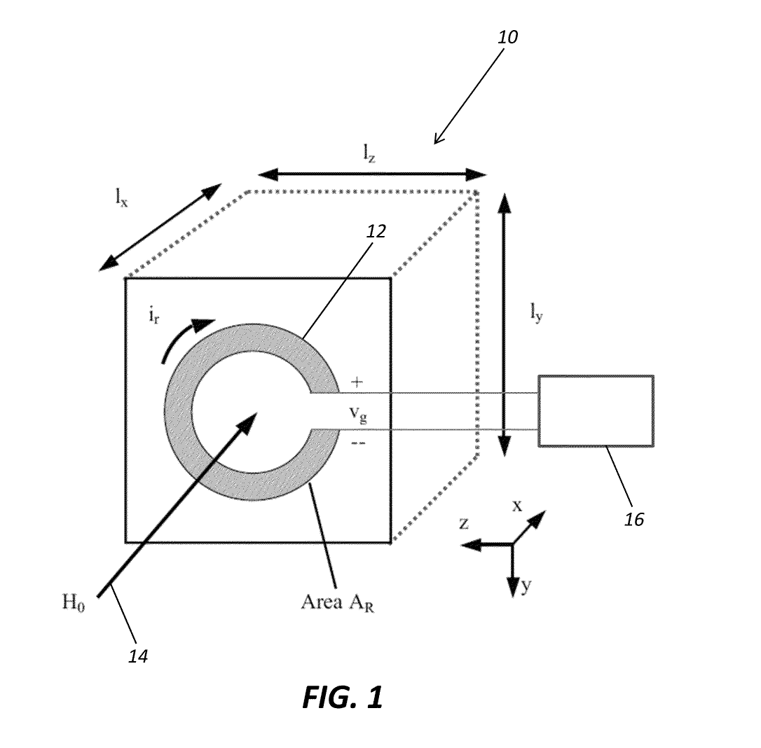

Consider the magnetic unit cell 10 and SSRR 12 illustrated in FIG. 1 that, in the prior art, is expected to exhibit typical narrowband resonant behavior. The dimensions of the unit cell 10 comprising this magnetic metamaterial particle are lₓ, l_{y}, and l_{z}, and the metal split ring 12 has an area A_{R}. As usual, the dimensions of the unit cell 10 are considered to be significantly smaller than a wavelength. The incident magnetic field Hₒ\hat{x} is parallel to the axis of the split ring 12.

As illustrated in FIG. 1, the current in the split ring 12 is defined as iᵣ, and the voltage across the gap is v_{g} (this sign convention for iᵣ and v_{g} is later convenient for describing the current through the capacitance of the gap in the split ring 12). Using Faraday's law of induction, the gap voltage is:

$${v}_{g} = - \frac{d {Φ}_{T}}{d t} = - \frac{d ( {Φ}_{0} + {Φ}_{R} )}{d t} , \qquad ( 1 )$$

where Φ_{T} is the total magnetic flux in the SSRR 12, Φ₀=μ₀H₀A_{R} is the incident magnetic flux over the SSRR 12, A_{R} is the area of the SSRR 12, μ₀ is the permeability of a vacuum, and Φ_{R} is the magnetic flux due to iᵣ. Then, the current in the ring 12 is:

$${i}_{r} = {C}_{g} \frac{d {v}_{g}}{d t} = - {C}_{g} \frac{{d}^{2} ( {Φ}_{0} + {Φ}_{R} )}{d {t}^{2}} , \qquad ( 2 )$$

where C_{g} is the total capacitance across the gap of the SSRR 12.

Taking the Laplace transform:

iᵣ=−s²C_{g}(Φ₀+Φ_{R})=−s²C_{g}(Φ₀+L_{R}iᵣ), (3)

where the self-inductance of the SSRR 12 is L_{R}=Φ_{R}/iᵣ.

Solving for iᵣ yields the frequency-dependent current:

$${i}_{r} = - {Φ}_{0} \frac{{s}^{2} {C}_{g}}{1 + {s}^{2} {L}_{R} {C}_{g}} , \qquad ( 4 )$$

Next, consider replacing the gap capacitance C_{g} with a positive inductance L_{g} with reactance X_{g}=jωL_{g}. The voltage v_{g} now appears across this gap inductance L_{g}. Then, the current in the split ring 12 becomes:

$${i}_{r} = \frac{1}{{L}_{g}} \int {v}_{g} d t = - \frac{1}{{L}_{g}} \int \frac{d ( {Φ}_{0} + {Φ}_{R} )}{d t} d t , \qquad ( 5 )$$

after substituting for v_{g} from Eq. (1). Taking the integral, and again with L_{R}=Φ_{R}/iᵣ, leads to:

$${i}_{r} = - \frac{1}{{L}_{g}} ( {Φ}_{0} + {Φ}_{R} ) = - \frac{1}{{L}_{g}} ( {Φ}_{0} + {L}_{R} {i}_{r} ) , \qquad ( 6 )$$

Then, solving for iᵣ results in:

$${i}_{r} = - {Φ}_{0} \frac{1}{{L}_{g} + {L}_{R}} , \qquad ( 7 )$$

Comparing Eq. (7) with Eq. (4), the ring current iᵣ in Eq. (7) no longer depends on frequency when the gap capacitance C_{g} is replaced by inductance L_{g}, allowing wideband behavior.

The current in the loop gives rise to a magnetic dipole moment in the SSRR 12 of m=iᵣAᵣ\hat{x}. The minus sign in Eq. (7) then results in m having a direction opposite to the applied field H₀\hat{x}. The macroscopic magnetization M is then the magnetic dipole moment per unit volume:

$$M = - {Φ}_{0} \frac{{A}_{R}}{{l}_{x} {l}_{y} {l}_{z}} \frac{1}{{L}_{g} + {L}_{R}} \hat{x} = - {μ}_{0} {H}_{0} \frac{{A}_{R}^{2}}{{l}_{x} {l}_{y} {l}_{z}} \frac{1}{{L}_{g} + {L}_{R}} \hat{x} , \qquad ( 8 )$$

where the permeability of free space is μ₀=1.26×10⁻⁶H/m, and for the simplicity of exposition, well-known mixing effects, such as Bruggeman's Effective Medium Theory, are not included here. With M=χₘH and μᵣ=1+χₘ, it follows that:

$${μ}_{r} = 1 - {μ}_{0} \frac{{A}_{R}^{2}}{{l}_{x} {l}_{y} {l}_{z}} \frac{1}{{L}_{g} + {L}_{R}} , \qquad ( 9 )$$

where χₘ is the magnetic susceptibility, and μᵣ is the effective relative permeability of the metamaterial.

The proposed effective relative permeability μᵣ for the SSRR 12 given in Eq. (9) does not vary with frequency, and becomes a large negative value if L_{g} is chosen to be negative, such that the denominator has (L_{g}+L_{R})>0 and (L_{g}+L_{R})≈0. Thus, a negative inductor load in the gap of a SSRR 12 can provide wideband negative effective permeability. The desired condition (L_{g}+L_{R})>0 has the same form as a series combination of a negative inductor with a positive inductor whose resulting inductance remains positive. Non-Foster circuits, such as a negative inductor, can be designed using negative impedance converters, where recent progress has been made in potential stability issues. Further, the condition (L_{g}+L_{R})>0 results in a net positive inductance, which leads to stability. The non-Foster element 16 is shown conceptually in FIG. 1.

Just as the theory of the SSRR 12 is developed above for wideband negative-permeability metamaterials, a similar approach is used to develop the theory for the proposed wideband negative-permittivity metamaterials. The analysis follows along similar lines as the analysis of the magnetic unit cell 10 of FIG. 1.

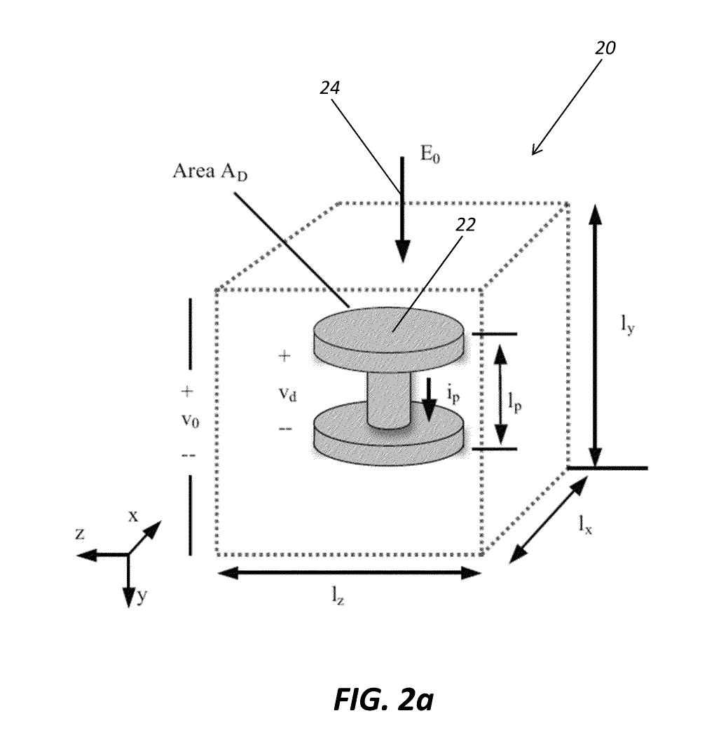

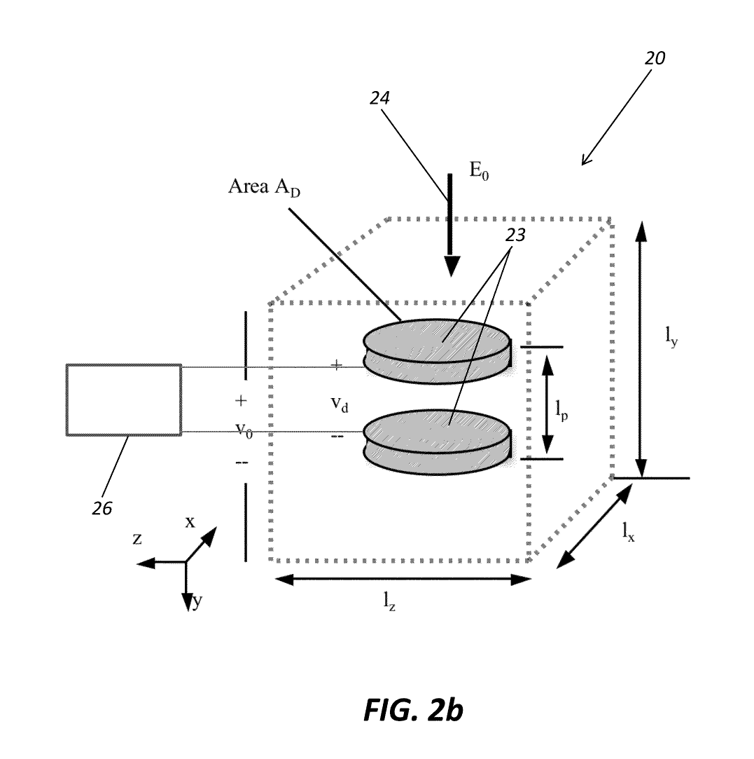

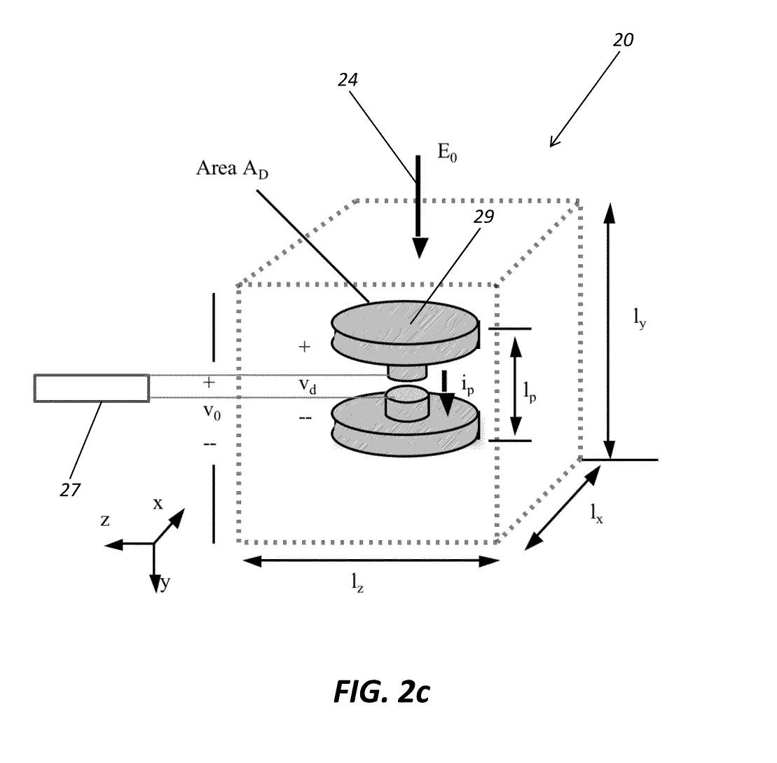

Consider the electric unit cell 20 and EDR 22 illustrated in FIG. 2, resembling a three-dimensional version of an I-shaped structure. The dimensions of the unit cell 20 comprising this electric metamaterial particle are the same as the magnetic component of FIG. 1, lₓ, l_{y}, and l_{z}. The metal disks near the top and bottom faces of the structure have areas A_{D}, and are connected together by a metal post with inductance Lₚ. As usual, the dimensions of the unit cell 20 are taken to be less than a wavelength, so that the incident electric field E₀ŷ24 is uniform over the unit cell 20. As illustrated in FIG. 2, the current in the post that connects the two disks is iₚ, and the voltage between the upper and lower disks is v_{d}.

Using Ampere's circuital law and the Maxwell-Ampere equation, the time derivative of the total electric flux impinging upon the top face of the upper disk equals the current in the post plus the time derivative of total electric flux departing the bottom face of the top disk:

$${i}_{p} = \frac{d}{d t} {Ψ}_{F} = \frac{d}{d t} {Ψ}_{T} , \qquad ( 10 )$$

where iₚ is the current in the post, Ψ_{T} is the total electric flux in coulombs impinging upon the top face of the upper disk of the EDR 22 from sources external to the unit cell 20, and Ψ_{F} is the total electric flux that couples between the upper and lower EDR disks (i.e. internal to the unit cell 20). The left side of Eq. (10) then represents the total current (both circuit current and displacement current) flowing from the top disk to the bottom disk, and the right side represents the total displacement current coming from sources external to the unit cell 20 and impinging on the top disk of the EDR 22.

The internal electric flux Ψ_{F} can be represented by a capacitance C_{F} driven by the voltage v_{d} across the two disks, and the external electric flux Ψ_{T} can be represented by a capacitance C₀ coupling to the external voltage potential across the unit cell 20 ν₀=E₀l_{y}, where E₀ŷ is the incident electric field. Then, Eq. (10) becomes:

$${i}_{p} = \frac{d}{d t} ( {v}_{0} {C}_{0} - {Ψ}_{F} ) = \frac{d}{d t} ( {v}_{0 } {C}_{0} - {v}_{d} {C}_{F} ) , \qquad ( 11 )$$

where capacitance C_{F} can also be thought of as a leakage capacitance or fringe capacitance around the post inductance. The voltage between the two disks also equals the voltage across the inductive post, so:

$${v}_{p} = {L}_{p} \frac{d {i}_{p}}{d t} = {L}_{p} \frac{{d}^{2}}{d {t}^{2}} ( {v}_{0 } {C}_{0} - {v}_{d} {C}_{F} ) , \qquad ( 12 )$$

where v_{d} is the voltage from the top disk to the bottom disk, as before, and Lₚ is the inductance of the metal post connecting the two disks. Taking the Laplace transform results in:

ν_{d}=s²Lₚ(ν₀C₀−ν_{d}C_{F}). (13)

Solving for the voltage v_{d} then gives:

$${v}_{d} = {v}_{0} \frac{{s}^{2} {L}_{p} {C}_{0}}{1 + {s}^{2} {L}_{p} {C}_{F}} . \qquad ( 14 )$$

Next, consider replacing the inductive post Lₚ with a positive capacitance Cₚ with reactance Xₚ=−j/(ωCₚ). The current iₚ then flows through this capacitance and the voltage v_{d} now appears across this capacitance, so:

$${v}_{d} = \frac{1}{{c}_{p}} \int {i}_{p} d t = \frac{1}{{c}_{p}} \int \frac{d}{d t} ( {v}_{0} {C}_{0} - {v}_{d} {C}_{F} ) d t , \qquad ( 15 )$$

after substituting for iₚ from Eq. (11). Simplifying and solving for v_{d} results in:

$${v}_{d} = \frac{1}{{c}_{p}} ( {v}_{0} {C}_{0} - {v}_{d} {C}_{F} ) = {v}_{0} \frac{{c}_{0}}{{c}_{p} + {c}_{F}} . \qquad ( 16 )$$

Comparing Eq. (16) with Eq. (14), note that the voltage v_{d} in Eq. (16) no longer depends on frequency when the post inductance Lₚ is replaced by Cₚ, thus allowing wideband behavior.

The charge on the disks then gives rise to an electric dipole moment:

$$p = q {l}_{p} \hat{y} = {v}_{d} {C}_{p} {l}_{p} \hat{y} = {v}_{0} {C}_{0} {l}_{p} \frac{{c}_{p}}{{c}_{p} + {c}_{F}} \hat{y} , \qquad ( 17 )$$

where ±q is the charge in coulombs on the disks, p is the electric dipole moment in the same direction as the applied field E₀ŷ, and lₚ is the distance between the two disks. In Eq. (17), the charge on the bottom disk is q=∫iₚdt and ν_{d}=(1/Cₚ)∫iₚdt, so q=ν_{d}Cₚ. Then, polarization P equals electric dipole moment per unit volume:

$$P = \frac{p}{{l}_{x} {l}_{y} {l}_{z}} = {E}_{0} \frac{{c}_{0} {l}_{p}}{{l}_{x} {l}_{z}} ( \frac{{c}_{p}}{{c}_{p} + {c}_{F}} ) \hat{y} , \qquad ( 18 )$$

after substituting E_{0l l}_{y}=ν₀, and for the simplicity of exposition, well-known mixing effects, such as Bruggeman's Effective Medium Theory, are again not included here. With P=χₑε₀E and Eᵣ=1+χₑ, the relative permittivity εᵣ is:

$${ε}_{r} = 1 + \frac{{c}_{0} {l}_{p}}{{ε}_{0} {l}_{x} {l}_{z}} ( \frac{{c}_{p}}{{c}_{p} + {c}_{F}} ) , \qquad ( 19 )$$

where χₑ is the electric susceptibility, εᵣ is the effective relative permittivity of the metamaterial, and ε₀=8.85×10 ⁻¹² F/m is the permittivity of free space.

Therefore, the effective relative permittivity εᵣ of the EDR 22 in Eq. (19) does not vary with frequency, just as there was no frequency dependence in μᵣ for the SSRR 12 result of Eq. (9). The effective permittivity εᵣ becomes a large negative value if Cₚ is chosen to be negative, such that the denominator has Cₚ+C_{F}≈0 and Cₚ+C_{F}>0. Thus, a negative capacitor load replacing the post of an EDR 22 can provide wideband negative effective permittivity. The desired condition Cₚ+C_{F}>0 has the same form as a parallel combination of a negative capacitor with a positive capacitor whose resulting capacitance remains positive. Further, the condition Cₚ+C_{F}>0 results in a net positive capacitance, which leads to stability. Non-Foster circuits, such as a negative capacitor, can be designed using negative impedance converters, where recent progress has been made in potential stability issues. The non-Foster element 26 is shown conceptually in FIG. 2b, where the non-Foster element 26 coupled the two disks 23, with the non-Foster element 26 replacing the inductive post of the EDR 22. In an alternative arrangement shown in FIG. 2c, the inductive post of the EDR 22 is cut in two, with the non-Foster element 27 coupling the remaining portions of the split EDR 29. Furthermore, in some applications, metamaterials do not necessarily need to exhibit negative permittivity and/or negative permeability, since devices with non-negative refractive indices less than unity or near zero can also be useful.

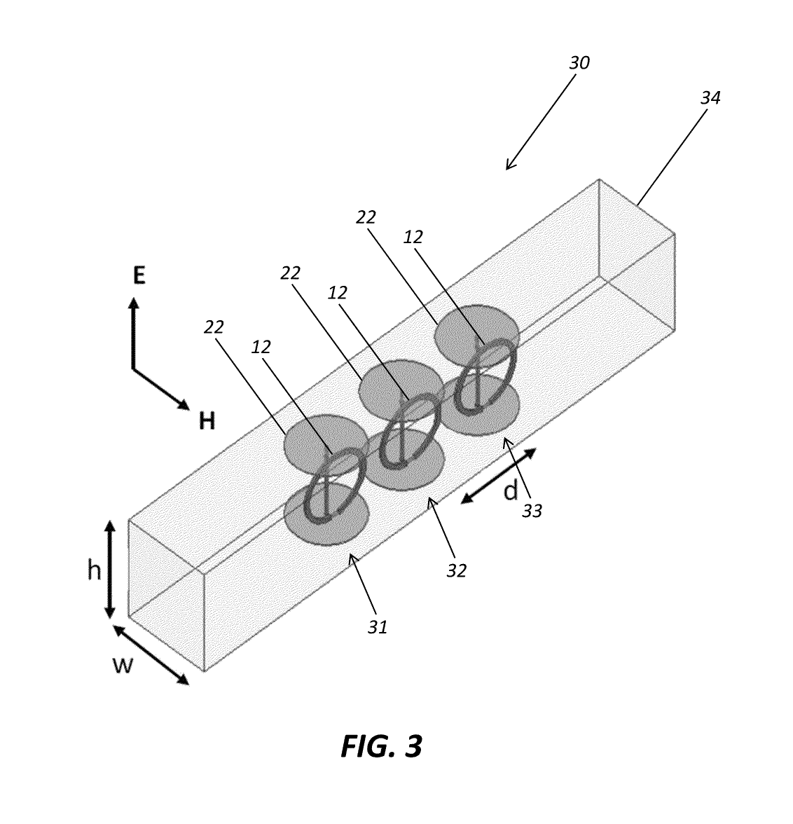

The wideband double-negative metamaterial test structure 30 illustrated in FIG. 3 was chosen to illustrate the performance of the proposed design. The structure consisted of three unit cells 31, 32, and 33 within a parallel-plate waveguide 34 with perfect electric conductor top and bottom walls separated by h=10 mm, and perfect magnetic conductor side walls separated by w=8 mm. The separation between unit cells was d=8 mm. The SSRR 12 had a radius of 3.2 mm with a 1-mm gap, and the EDR 22 was comprised of two disks 7 mm apart with 3.2-mm radius and a connecting post of 0.15-mm radius. The EDR 22 and SSRR 12 were centered within the waveguide 34, with 1-mm space between the EDR post and SSRR ring. Each EDR 22 had a 1-mm gap in its post with a negative capacitance of Cp=−240 fF placed in the gap. Each SSRR 12 had a 1-mm gap in its ring with a negative inductance of Lp=−10 nH placed in the gap. In addition, a negative capacitance of −45 fF was placed in parallel to Lp to compensate for stray capacitance in the ring 12 to help improve bandwidth.

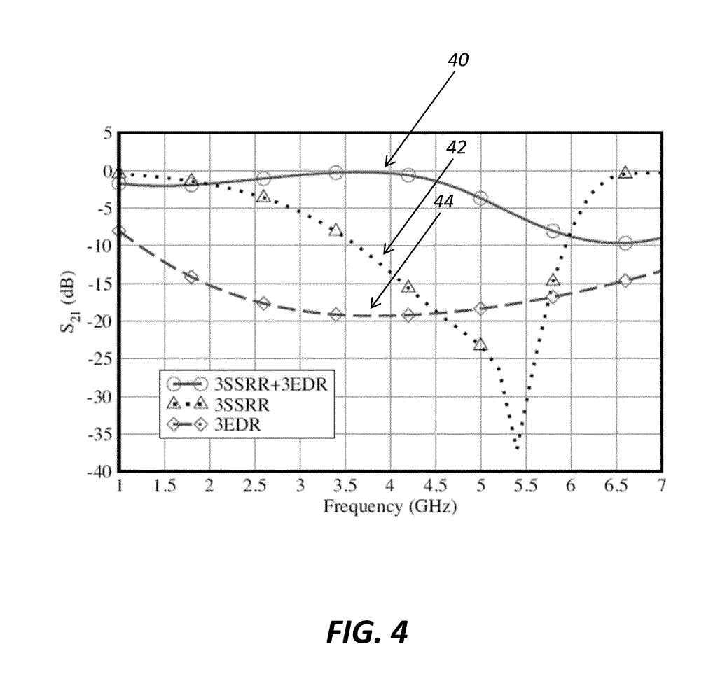

The structure 30 of FIG. 3 was tested in the HFSS 3D electromagnetic simulator. FIG. 4 illustrates the S-parameter simulation results for S₂₁ for three cases. The solid curve with circles 40 in FIG. 4 illustrates |S₂₁| in dB for the entire structure 30 of FIG. 3, and illustrates wideband double-negative behavior with less than 2 dB loss from 1.0 to 4.5 GHz. The dotted curve with triangles 42 illustrates |S₂₁| for the three SSRR devices 12, with the three EDR devices 22 removed. In the dotted curve 42, the insertion loss is due to the negative effective permeability of the three SSRR devices 12 alone. The dashed curve with diamonds 44 shows |S₂₁| for the three EDR devices 22, with the three SSRR devices 12 removed. In the dashed curve 44, the insertion loss is due to the negative effective permittivity of the three EDR devices 22 alone.

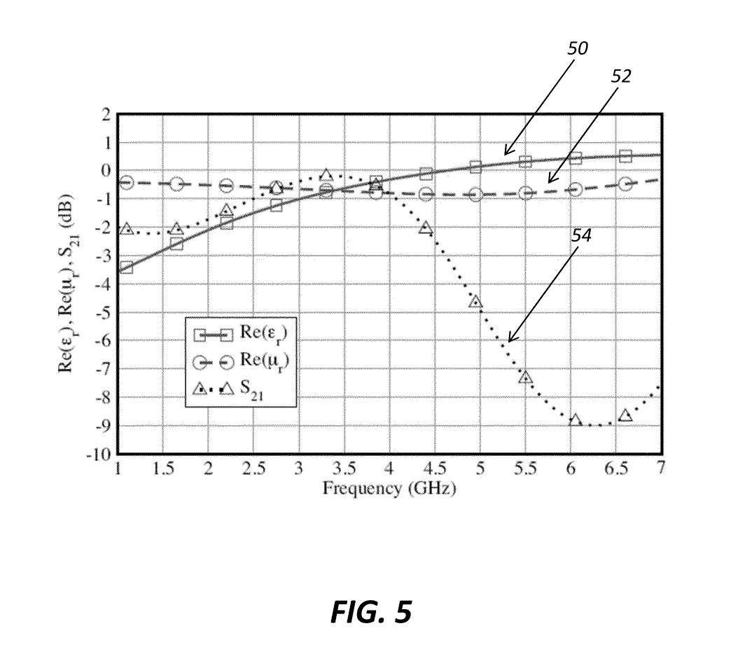

The effective permeability and effective permittivity of the three unit cell structure 30 of FIG. 3 were extracted from the S-parameters of FIG. 4, drawing upon common methods. FIG. 5 illustrates the real part of the effective relative permittivity (solid curve with squares 50) and the real part of the effective relative permeability (dashed curve with circles 52), both on a linear scale. The dotted curve with triangles 54 shows |S₂₁| in dB for reference. Note that both the real parts of the relative permittivity εᵣ and relative permeability μᵣ remain negative from 1.0 to 4.5 GHz. Near 1 GHz, the real part of εᵣ approaches −3.5, while the real part of μᵣ approaches −0.3. Near 5 GHz, εᵣ becomes positive while μᵣ remains negative, suggesting an evanescent nonpropagating condition above 4.5 GHz. Also, the attenuation greatly increases above 5 GHz, as would be expected when εᵣ becomes positive while μᵣ remains negative. Further, the effective relative permittivity is between 0 and 1 from 5 GHz to 7 GHz.

Analysis and simulation results for the proposed non-Foster metamaterial 30 confirm wideband double-negative behavior. Effective permittivity and permeability were extracted from S-parameters and confirm simultaneous negative permittivity and negative permeability from 1.0 to 4.5 GHz.

Again, magnetic metamaterial unit cells 10 are commonly narrowband and dispersive. However, the appropriate use of non-Foster elements 16 can increase the bandwidth of the metamaterials. Therefore, the present invention further addresses the deleterious effects of parasitic fringe capacitance on the bandwidth of a SSRR 12 when loaded with an ideal non-Foster circuit element 16. Analysis of the parasitics leads to modified equations for effective permeability, and simulation results confirm the potential for significantly improved bandwidth.

For simplicity, a lossless SSRR 12 is used to illustrate the influence of parasitic fringe capacitance on the effective permeability of the metamaterial when using non-Foster elements 16. Consider again the SSRR 12 illustrated in FIG. 1, centered in a unit cell 10 with dimensions lₓ, l_{y}, and l_{z}. The area of the SSRR 12 is A_{R} and the incident magnetic field H₀ 14 is parallel to the axis of the SSRR 12. Due to the change in the magnetic field, a voltage v_{g} appears across the gap of the ring 12. The gap in the ring 12 can be modeled as a capacitance C_{g}. The current iᵣ in the ring 12 and through capacitance C_{g} is then:

$${i}_{r} = {C}_{g} \frac{d {v}_{g}}{d t} = - {C}_{g} \frac{{d}^{2} ( {Φ}_{0} + {Φ}_{R} )}{d t} = - {Φ}_{0} \frac{{s}^{2} {C}_{g}}{1 + {s}^{2} {L}_{R} {C}_{g}} , \qquad ( 20 )$$

where s is the Laplace complex angular frequency, L_{R}=Φ_{R}/iᵣ is self-inductance, ν_{g}=−d(Φ₀+Φ_{R})/dt, Φ₀ is the incident magnetic flux, and Φ_{R} is the magnetic flux due to iᵣ. The well-known result in Eq. (20) describes the conventional narrowband behavior of a SSRR 12, where the magnetic resonance frequency can be defined as ω₀ₘ−1/\sqrt{L_{R}C_{G}}.

Next, consider replacing gap capacitance C_{g} with a positive inductance L_{g} with reactance X_{L}=jωL_{g}. The ring current iᵣ then becomes:

$${i}_{r} = \frac{1}{{L}_{g}} \int {v}_{g} d t = - \frac{1}{{L}_{g}} ( {Φ}_{0} + {Φ}_{R} ) = - {Φ}_{0} \frac{1}{{L}_{g} + {L}_{R}} . \qquad ( 21 )$$

Comparing Eq. (20) with Eq. (21), the current in the split ring 12 is now frequency independent and broadband behavior is possible with proper choice of inductance L_{g}.

In some cases, however, capacitance C_{g} cannot be removed completely, and some parasitic fringe capacitance C_{Fg} will remain. As a result, the equivalent circuit in the gap of the split-ring 12 is now a parallel combination of inductance L_{g} and fringe capacitance C_{Fg}. Modifying Eq. (21) with C_{Fg} yields:

$${i}_{r} = {i}_{{C}_{Fg}} + {i}_{{L}_{g}} = {C}_{Fg} \frac{d {v}_{g}}{d t} + \frac{1}{{L}_{g}} \int {v}_{g} d t , \qquad ( 22 )$$

where i_{CFg} is the current through fringe capacitance C_{Fg}, and i_{Lg} is the current through inductance L_{g}. Substituting ν_{g}=−d(Φ₀+Φ_{R})/dt in Eq. (22), taking the Laplace transform, and including self-inductance L_{R} yields:

$${i}_{r} = - {Φ}_{0} \frac{1 + {s}^{2} {C}_{Fg} {L}_{g}}{{L}_{R} + {L}_{g} ( 1 + {s}^{2} {C}_{Fg} {L}_{R} )} , \qquad ( 23 )$$

The result in Eq. (23) indicates that two resonance frequencies exist.

To find the effective permeability, the magnetic dipole moment is used. The current in the SSRR 12 creates a magnetic dipole moment m=(iᵣA_{R}), and the macroscopic magnetization is then M=(iᵣA_{R})/(lₓl_{y}l_{z}). Since M=χₘH, μᵣ=1+χₘ, and Φ₀=μ₀HₒA_{R}, the relative permeability, μᵣ, equals:

$${μ}_{r} = 1 - {μ}_{0} \frac{{A}_{R}^{2}}{{l}_{x} {l}_{y} {l}_{z}} \frac{1 - {ω}^{2} {C}_{Fg} {L}_{g}}{{L}_{R} + {L}_{g} ( 1 - {ω}^{2} {C}_{Fg} {L}_{R} )} , \qquad ( 24 )$$

where χₘis the magnetic susceptibility, ω is the angular frequency, μ₀=1.26×10⁻⁶H/m is the permeability of free space, and s=jω was used, and for the simplicity of exposition, well-known mixing effects, such as Bruggeman's Effective Medium Theory, are again not included here.

Finally, the parasitic fringe capacitance C_{Fg} can theoretically be canceled by adding a parallel negative capacitance of equal value such that Eq. (24) becomes:

$${μ}_{r} = 1 - {μ}_{0} \frac{{A}_{R}^{2}}{{l}_{x} {l}_{y} {l}_{z}} \frac{1}{{L}_{R} + {L}_{g}} , \qquad ( 25 )$$

and μᵣ once again becomes frequency independent, making wideband negative effective permeability possible when L_{g} is negative, L_{R}+L_{g}>0, and L_{R}+L_{g}≈0, according to Eq. (25).

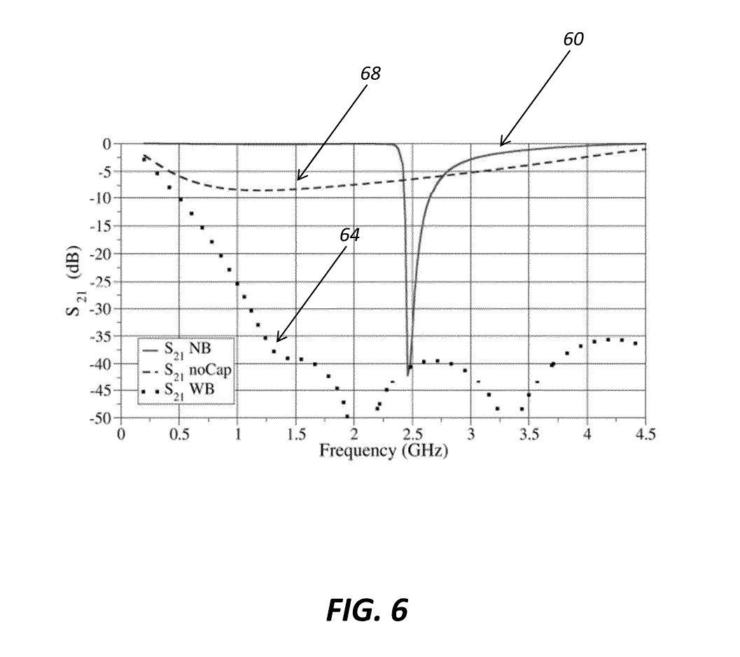

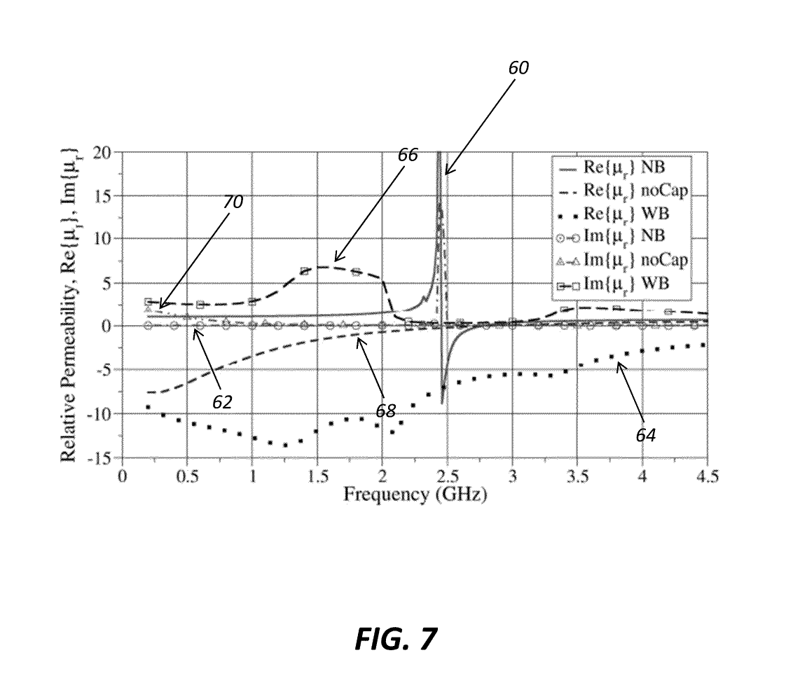

Again, the metamaterial structure 30 illustrated in FIG. 3 was simulated with three SSRR devices 12 in a parallel-plate waveguide 34 with perfect electric conductor top and bottom walls and with perfect magnetic conductor side walls, however, with the three EDRs 22 removed in the following three cases. Three cases were simulated. The first case used conventional SSRR devices 12 without non-Foster circuit elements 16. In the second case, all three SSRR devices 12 were loaded with negative capacitance of −47 fF and negative inductance of −16.7 nH to confirm wideband behavior as predicted in Eq. (25). In the final case, the negative capacitance was removed and all three SSRR devices 12 were only loaded with a negative inductance. For the three cases simulated, S₂₁ is plotted in FIG. 6 and extracted real and imaginary parts of the effective relative permeability are illustrated in FIG. 7. For both FIGS. 6 and 7, the solid 60 and circle 62 curves describe the conventional narrowband behavior. The magnetic resonance occurs near 2.5 GHz. The dotted 64 and dashed (square) 66 curves illustrate wideband behavior from 0.5 to 4.5 GHz, when both the negative inductance and negative capacitance are present. The dashed 68 and triangle 70 curves depict the result when the negative capacitance is removed.

The deleterious effects of fringe capacitance were analyzed and found, in some cases, to limit the bandwidth of negative effective permeability in non-Foster-loaded SSRRs. The analysis and simulation results demonstrate that a non-Foster load with both negative inductance and negative capacitance is required for wideband behavior, in some cases. As is well known to those of ordinary skill in the art, arrangements of the SSRRs and EDRs of FIG. 3 can be configured to respond to fields along different axes, along two axes, or along all three axes to provide an isotropic medium. An exemplary isotropic medium would orient the unit cells of FIG. 3 along the x, y, and z axes.

As illustrated in the exemplary embodiments provided herein above, the present invention provides wideband metamaterials using non-Foster elements, with inherent stability advantages, and that can be used in a three-dimensional volume, can provide wideband relative permittivity less than unity, can provide wideband relative permeability less than unity, can provide wideband simultaneous relative permittivity and relative permeability less than unity, can provide wideband negative relative permittivity, can provide wideband negative relative permeability, can provide wideband simultaneous negative relative permittivity and negative relative permeability, that does not require a ground plane, and that can compensate for the deleterious effects of stray capacitance. In applications where instability is desirable, such as in oscillators, it is straightforward to violate the stability conditions noted throughout.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A metamaterial exhibiting an effective relative permeability below unity over a wide bandwidth, comprising:
one of a two-dimensional and a three-dimensional arrangement of unit cells, wherein each of the unit cells has a magnetic dipole moment that is dependent upon one or more of an incident magnetic field and an incident electric field; and
a coupling mechanism operable for coupling one or more of the incident magnetic field and the incident electric field to a device.

2. The metamaterial of claim 1, wherein the coupling mechanism comprises a split ring.

3. The metamaterial of claim 1, wherein the device comprises a non-Foster element.

4. The metamaterial of claim 3, wherein the non-Foster element comprises an arrangement of one or more negative capacitors.

5. The metamaterial of claim 3, wherein the non-Foster element comprises an arrangement of one or more negative inductors.

6. The metamaterial of claim 3, wherein the non-Foster element comprises an arrangement of one or more negative resistors.

7. The metamaterial of claim 3, wherein the non-Foster element comprises an arrangement of a negative capacitor in parallel with a negative inductor.

8. The metamaterial of claim 3, wherein the non-Foster element comprises one or more of an active circuit and a transistor.

9. A metamaterial exhibiting an effective relative permittivity below unity over a wide bandwidth, comprising:
one of a two-dimensional and a three-dimensional arrangement of unit cells, wherein each of the unit cells has an electric dipole moment that is dependent upon one or more of an incident magnetic field and an incident electric field; and
a coupling mechanism operable for coupling one or more of the incident magnetic field and the incident electric field to a device.

10. The metamaterial of claim 9, wherein the coupling mechanism comprises a pair of parallel plates coupled by one of a rod and a wire.

11. The metamaterial of claim 9, wherein the device comprises a non-Foster element.

12. The metamaterial of claim 11, wherein the non-Foster element comprises an arrangement of one or more negative capacitors.

13. The metamaterial of claim 11, wherein the non-Foster element comprises an arrangement of one or more negative inductors.

14. The metamaterial of claim 11, wherein the non-Foster element comprises an arrangement of one or more negative resistors.

15. The metamaterial of claim 11, wherein the non-Foster element comprises one or more of an active circuit and a transistor.

16. A metamaterial simultaneously exhibiting an effective relative permeability and an effective relative permittivity below unity over a wide bandwidth, comprising:
one of a two-dimensional and a three-dimensional arrangement of unit cells, wherein each of the unit cells has a magnetic dipole moment and an electric dipole moment that are dependent upon one or more of an incident magnetic field and an incident electric field; and
a coupling mechanism operable for coupling one or more of the incident magnetic field and the incident electric field to one or more devices.

17. The metamaterial of claim 16, wherein the coupling mechanism comprises one or more of a split ring and a pair of parallel plates coupled by one of a rod and a wire.

18. The metamaterial of claim 16, wherein the one or more devices comprise one or more non-Foster elements.

19. The metamaterial of claim 18, wherein a non-Foster element of the one or more non-Foster elements comprises an arrangement of one or more negative capacitors.

20. The metamaterial of claim 18, wherein a non-Foster element of the one or more non-Foster elements comprises an arrangement of one or more negative inductors.

21. The metamaterial of claim 18, wherein a non-Foster element of the one or more non-Foster elements comprises an arrangement of one or more negative resistors.

22. The metamaterial of claim 18, wherein a non-Foster element of the one or more non-Foster elements comprises an arrangement of a negative capacitor in parallel with a negative inductor.

23. The metamaterial of claim 18, wherein a non-Foster element of the one or more non-Foster elements comprises one or more of an active circuit and a transistor.

24. The metamaterial of claim 16, wherein the unit cells are alternately oriented along the x and y axes.

25. The metamaterial of claim 16, wherein the unit cells are alternately oriented along the x, y, and z axes.
